(19) United States
(12) Patent Application Publication
(10) Pub. No.: US 2004/0143405 A1
(43) Pub. Date: Jul. 22, 2004

(54) AUTOMATICALLY TURNING ON A PORTABLE DEVICE BY DETECTING A BATTERY CONDITION

(76) Inventors: Jung-Yuan Tsai, Tao-Yuan City (TW); Wan-Ting Tsai, Tao-Yuan City (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,292

(22) Filed: Jul. 9, 2003

(30) Foreign Application Priority Data
Jan. 20, 2003 (TW) 092101071

(51) Int. Cl. G06F 19/00

(52) U.S. Cl. 702/63

(57) ABSTRACT

A portable device includes a housing, a sensor, an operating processor, and a starting module. The housing is used for accommodating a detachable battery, and the detachable battery provides main power for operations of the portable device. The sensor that is installed inside the housing is used for detecting conditions of the detachable battery. The operating processor is used for controlling operations of the portable device, and the starting module is connected between the sensor and the operating processor. After the sensor detects that the detachable battery is correctly installed in the housing, the starting module outputs a turn-on signal to the operating processor for automatically turning on the portable device.

### BACKGROUND OF INVENTION

1. Field of the Invention

The invention relates to a portable device, and more particularly, to a portable device that can be automatically turned on by detecting a battery condition.

2. Description of the Prior Art

Nowadays, when users want to replace a battery in a portable device, they have to store the processed data first before they turn off the electronic device for avoiding any loss or damage of data. In addition, if there is any blunder during the battery-replacing process, such as an improper installation or wrong battery type, turning on the electronic device may lead to non-repairable damage toward the electronic device. Therefore, most commercialized portable electronic products are equipped with functions for supervising the battery conditions, especially for monitoring the battery-replacing process. For instance, regarding the design of the commercialized PDA, some crucial data are stored in a RAM so that the PDA should be constantly provided with power. If the electric power of the PDA is insufficient, all the stored data will be lost. Therefore, the common PDA uses two batteries, a main battery for providing main power for operations of the PDA and a backup battery for providing power to maintain the data in the RAM before the main battery is correctly installed in the PDA. Moreover, a monitor device is generally installed in the PDA so that the PDA can be turned on and then properly operate after the main battery is detected (by the monitor device) to be correctly installed in the PDA.

The related structure for monitoring the battery conditions are widely used and disclosed. In U.S. Pat. No. 6,332,113, “Electronic battery tester”, Bertness et. al. disclose a mechanism for detecting the type of the battery according to the dynamic parameters of the cells that compose of the battery. The mechanism can generate a standard reference to judge various characteristics of the battery based on a certain quantity of measurement results. Actually, many prior-art patents related to the battery-condition detection were written as early as 1960. Leonard et. al. install a circuitry in a vessel for accommodating the battery to detect the power capacity of the battery in U.S. Pat. No. 3,356,936, “Method and Means for total Battery Voltage Testing”. Recently, Vonderhaar et. al. make use of an electrical connector to provide tight contact and superior fixing mechanism for accommodating the battery in U.S. Pat. No. 6,469,511, “Battery clamp with embedded environment sensor”. They also make use of the environment sensor that is electrically connected to the electrical connector to detect various battery conditions. Please refer to FIG. 1, which is a functional block diagram of a portable device 10 according to the prior art. The portable device 10 includes a detachable battery 12 that can be detachably installed in the portable device 10 for providing main power for operations of the portable device 10. The portable device 10 further includes a battery vessel 14 and a battery cover plate 16 for accommodating a detachable battery 12. The battery cover plate 16 is detachably joined with the battery vessel 14, and a sensor 18 installed on the battery cover plate 16 can be used to detect if the battery cover plate 16 is correctly joined with the battery vessel 14 after the detachable battery 12 is put inside the battery vessel 14. The portable device 10 also includes an operating processor 20 and a backup battery 22. The operating processor 20 is used to control operations of the portable device 10. The backup battery 22 can provide a minor DC operating voltage for partial operations of the portable device 10 before the detachable battery 12 is correctly installed. After the detachable battery 12 is correctly installed, the detachable battery 12 can provide a major DC operating voltage to the operating processor 20 of the portable device 10, so that the portable device 10 can be turned on by pressing a manual button 23. Certainly, the portable device 10 cannot be turned on by pressing a manual button 23 until the sensor 18 on the battery cover plate 16 detects that the detachable battery 12 is correctly installed in the portable device 10 and transmits a related signal to the operating processor 20.

Regarding the above-mentioned prior-art technique, after the detachable battery 12 is correctly installed, the operating processor 20 cannot operate immediately. Therefore, the related functions, such as charging and battery-capacity detection, cannot be performed until a manual button is pressed, which causes inconvenience to users.

### SUMMARY OF INVENTION

It is therefore a primary objective of the claimed invention to provide aportable device that can be automatically turned on by detecting a battery condition to solve the above-mentioned problems.

According to the claimed invention, aportable device comprises a housing for accommodating a detachable battery, the detachable battery providing main power for operations of the portable device; a sensor installed in the housing for detecting conditions of the detachable battery; an operating processor for controlling operations of the portable device; and a starting module electrically connected to the sensor for outputting a turn-on signal to the operating processor so as to automatically turn on the portable device after the sensor detects the detachable battery being correctly installed in the housing.

According to the claimed invention, a portable device that can be automatically turned on by detecting conditions of a battery, which is detachably installed in the portable device for providing main power for operations of the portable device, is proposed. The portable device comprises a housing for accommodating the battery, the housing comprising a battery vessel and a battery cover plate, wherein the battery cover plate is detachably joined with the battery vessel for conveniently replacing the battery installed in the battery vessel; a sensor installed in the housing for detecting conditions of the battery cover plate and the battery to determine if the battery is correctly installed the battery vessel and the battery cover plate is correctly joined with the battery vessel; an operating processor for controlling operations of the portable device; and a starting module electrically connected to the sensor for outputting a turn-on signal to the operating processor to automatically turn on the portable device after the battery is correctly installed in the battery vessel and the battery cover plate is correctly joined with the battery vessel.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a portable device according to the prior art.

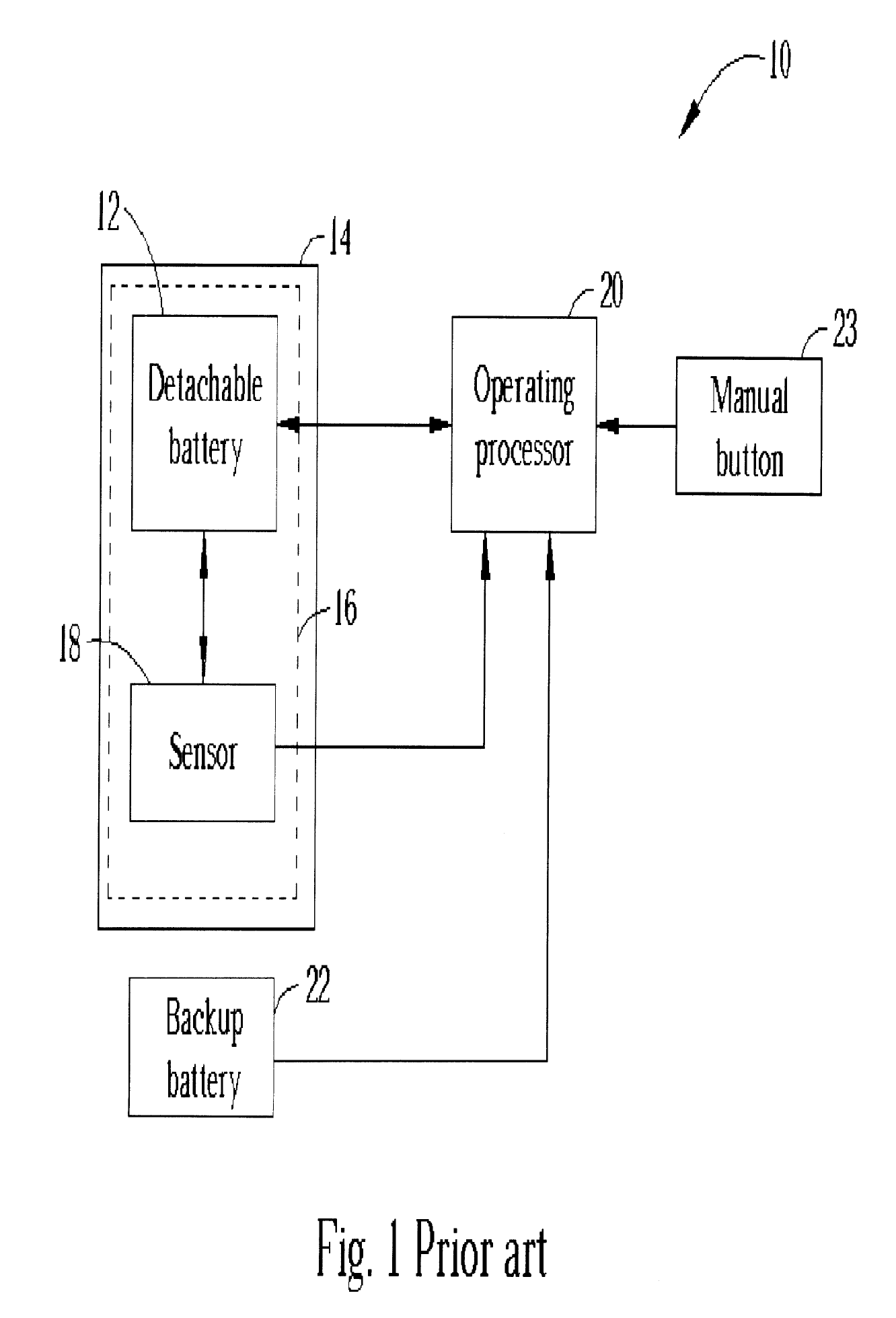

FIG. 2 is a functional block diagram of an embodiment of the portable device according to the present invention.

FIG. 3 is a functional block diagram of a practical embodiment of the starting module shown in FIG. 2.

FIG. 4 is a functional block diagram of another embodiment of the portable device according to the present invention.

FIG. 5 is a flow chart showing the replacement procedure of the battery shown in FIG. 4.

FIG. 6. is a schematic diagram of a practical embodiment of the starting module shown in FIG. 4.

### DETAILED DESCRIPTION

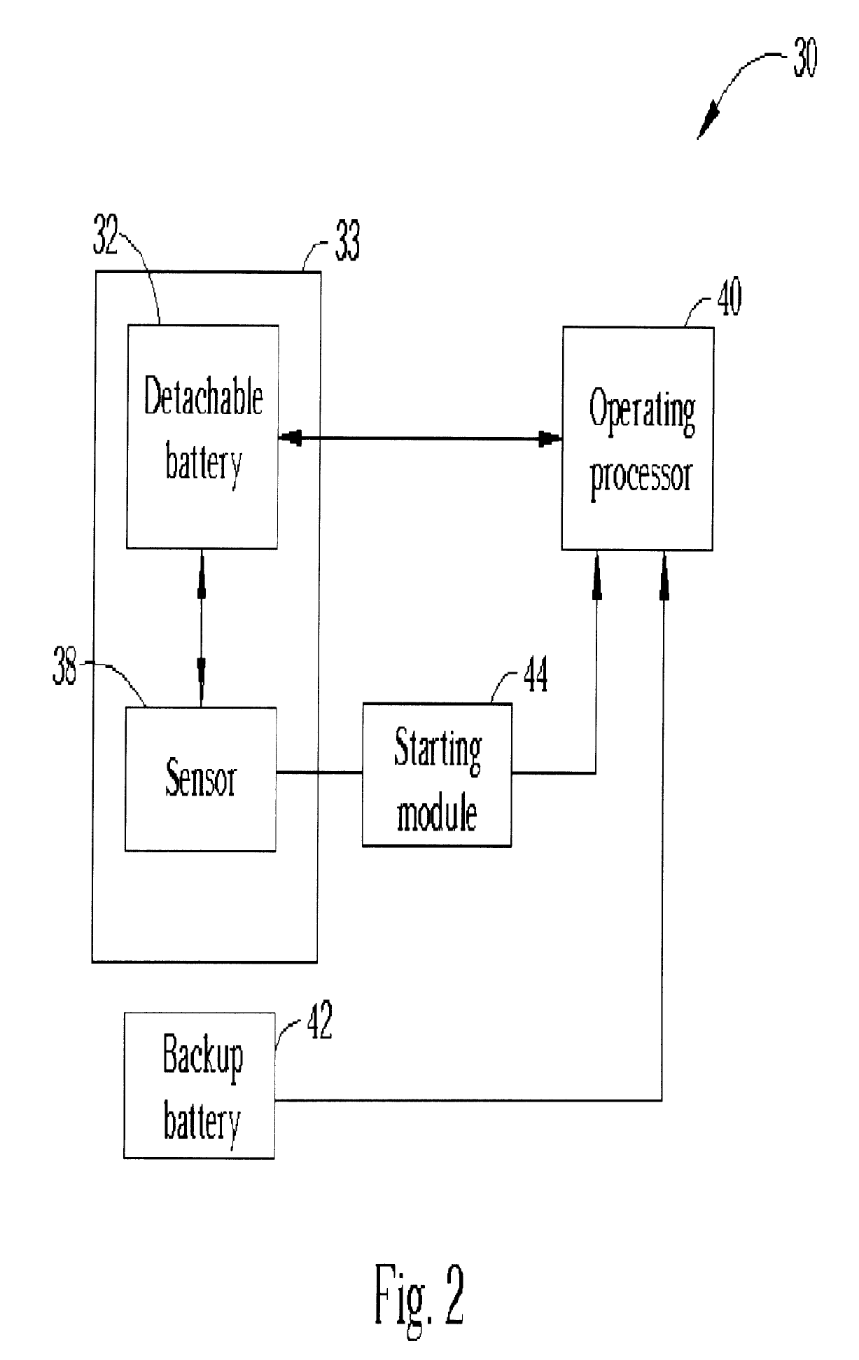

Please refer to FIG. 2, which is a functional block diagram of an embodiment of the portable device 30 according to the present invention. The portable device 30 includes a detachable battery 32, a housing 33, a sensor 38, an operating processor 40, and a starting module 44. The housing 33 is used for accommodating the detachable battery 32. After the detachable battery 32 is correctly installed in the housing 33, the detachable battery 32 can provide main power for operations of the portable device 30. The sensor 38 is installed in the housing 33 for detecting conditions of the detachable battery 32. The operating processor 40 is used to control operations of the portable device 30. In addition, the installation of the starting module 44 is the most important characteristic of the embodiment according to the present invention. The starting module 44 is electrically connected to the sensor 38. After the sensor 38 detects that the detachable battery 32 is correctly installed in the housing 33, the starting module 44 will output a turn-on signal to the operating processor 40 to automatically turn on the portable device 30. The portable device 30 further includes a backup battery 42 for providing power for partial operations of the operating processor 40 after the original detachable battery 32 is taken out and before the new detachable battery 32 is correctly installed in the housing 33.

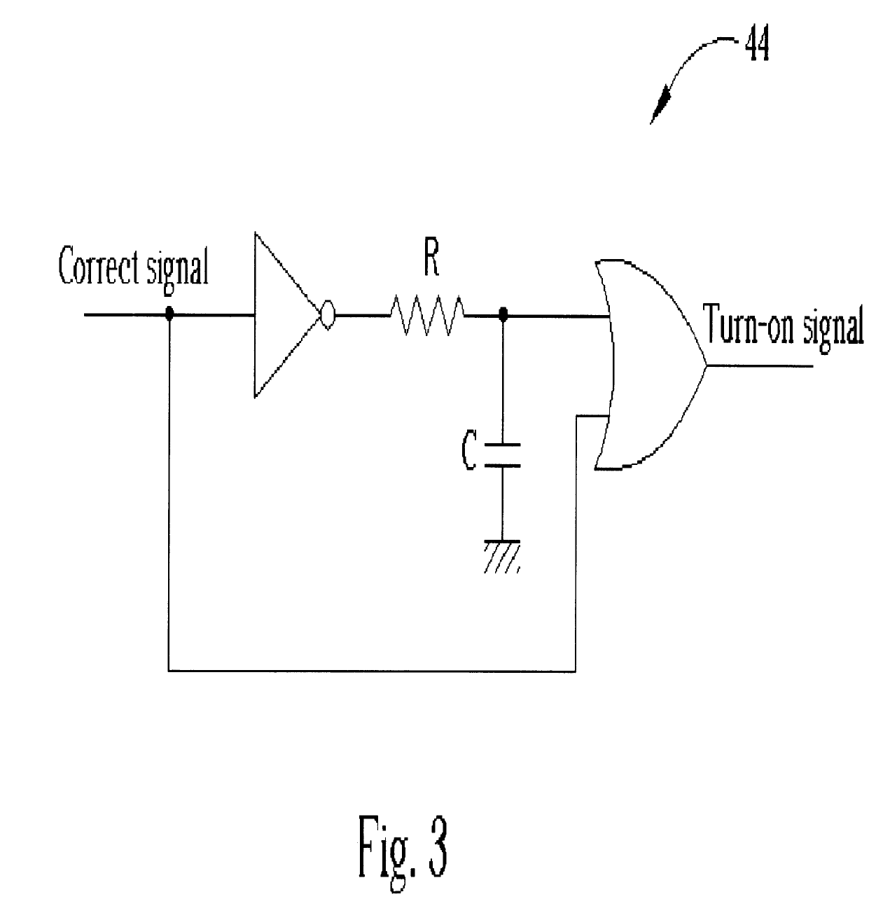

FIG. 3 shows a practical embodiment of the starting module 44 shown in FIG. 2. In the present embodiment, the starting module 44 is composed of the resistor R, the capacitor C, and other electronic devices. After the detachable battery 32 is correctly installed in the housing 33, the sensor 38 will output a correct signal to the starting module 44. Afterwards, based on an RC delay caused by the resistor R and the capacitor C in the starting module 44, the starting module 44 will convert the correct signal into a turn-on signal and output the turn-on signal to the operating processor 40 so as to turn on the portable device 30.

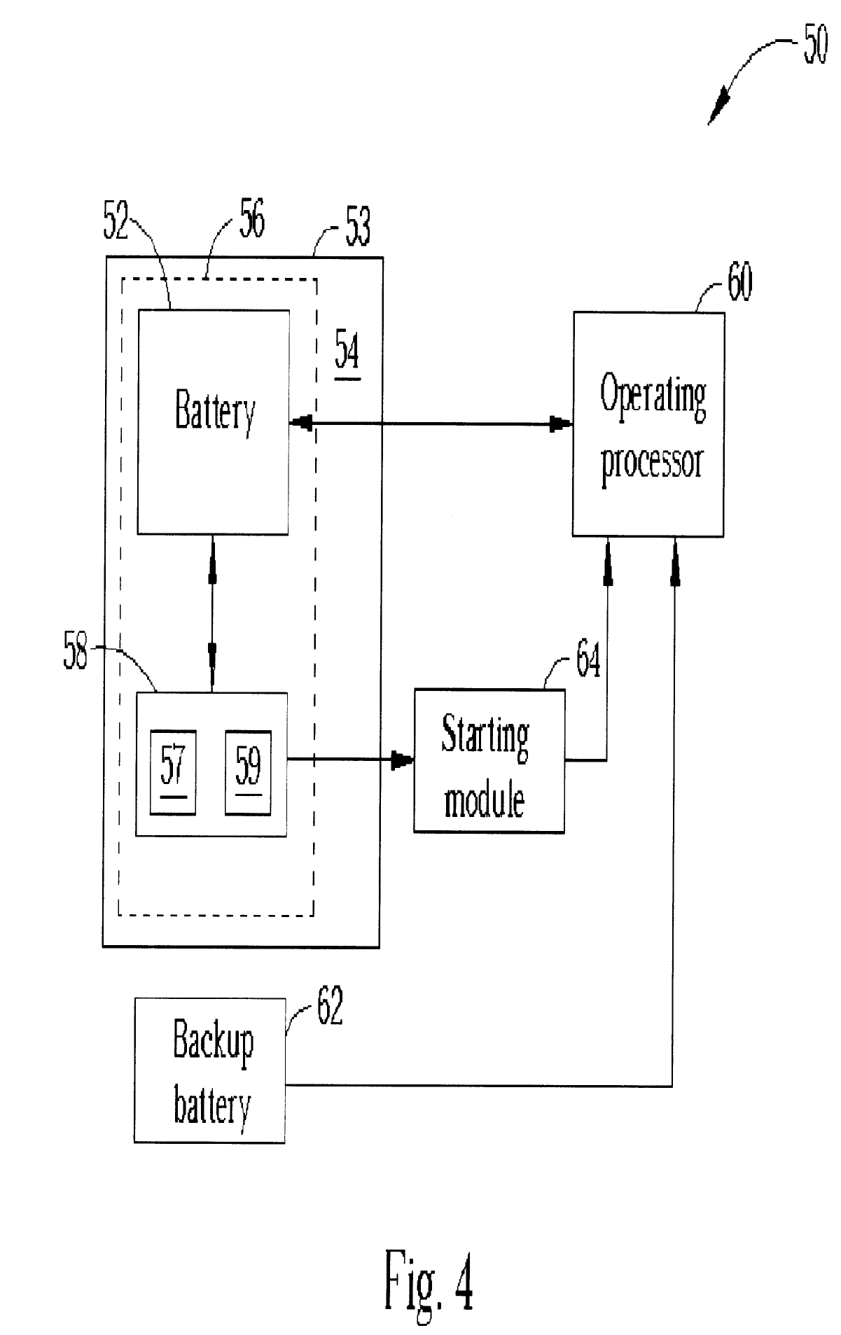

Please refer to FIG. 4, which is a functional block diagram of another embodiment of the portable device 50 according to the present invention. The portable device 50 of this embodiment also includes a (detachable) battery 52, a housing 53, a sensor 58, an operating processor 60, a backup battery 62, and a starting module 64. The housing 53 is used for accommodating the battery 52. The housing 53 includes a battery vessel 54 and a battery cover plate 56. The battery cover plate 56 is detachably joined with the battery vessel 54 for conveniently replacing the battery 52 inside the housing 53. The sensor 58 is installed in the housing 53. In the present embodiment, the sensor 58 includes a conducting port 57 and a cover triggering port 59. The conducting port 57 is used to detect the type of the battery 52, volume of the battery 52, and if the battery 52 is correctly installed in the battery vessel 54. The cover triggering port 59 is used to detect if the battery cover plate 56 is correctly joined with the battery vessel 54. Therefore, the sensor 58 can simultaneously detect the condition of the battery cover plate 56 and the condition of the battery 52. When the sensor 58 detects that the battery 52 is correctly installed in the battery vessel 54, the type of the battery 52 is correct, the power volume of the battery 52 is sufficient, and the battery cover plate 56 is correctly joined with the battery vessel 54, then the battery 52 is faultlessly installed. In the meanwhile, the starting module 64 will output the turn-on signal to the operating processor 60 to automatically turn on the portable device 50.

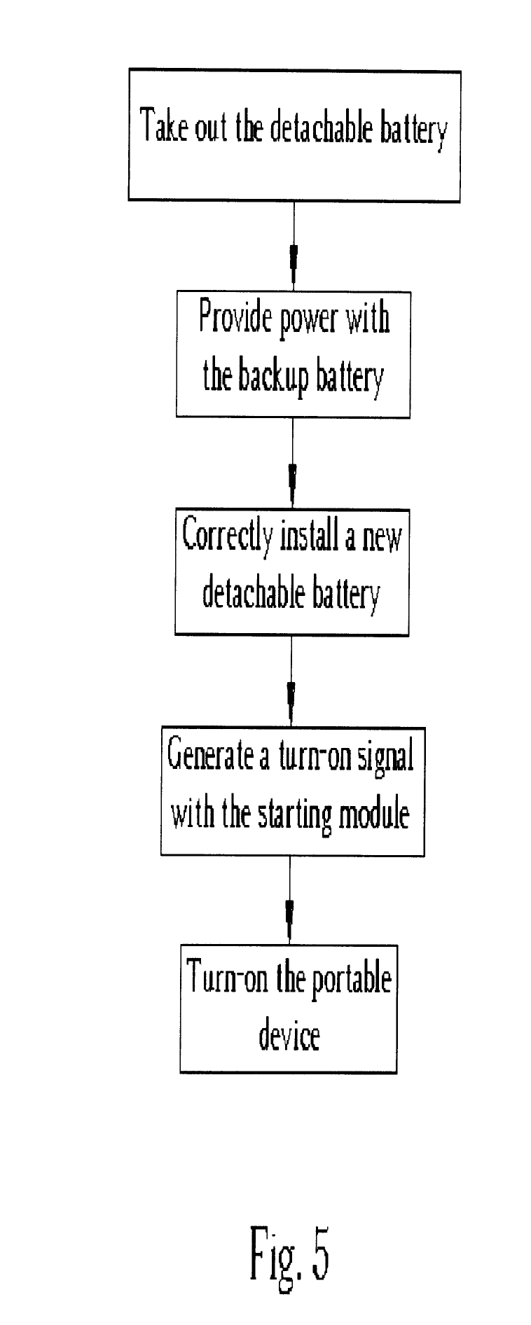

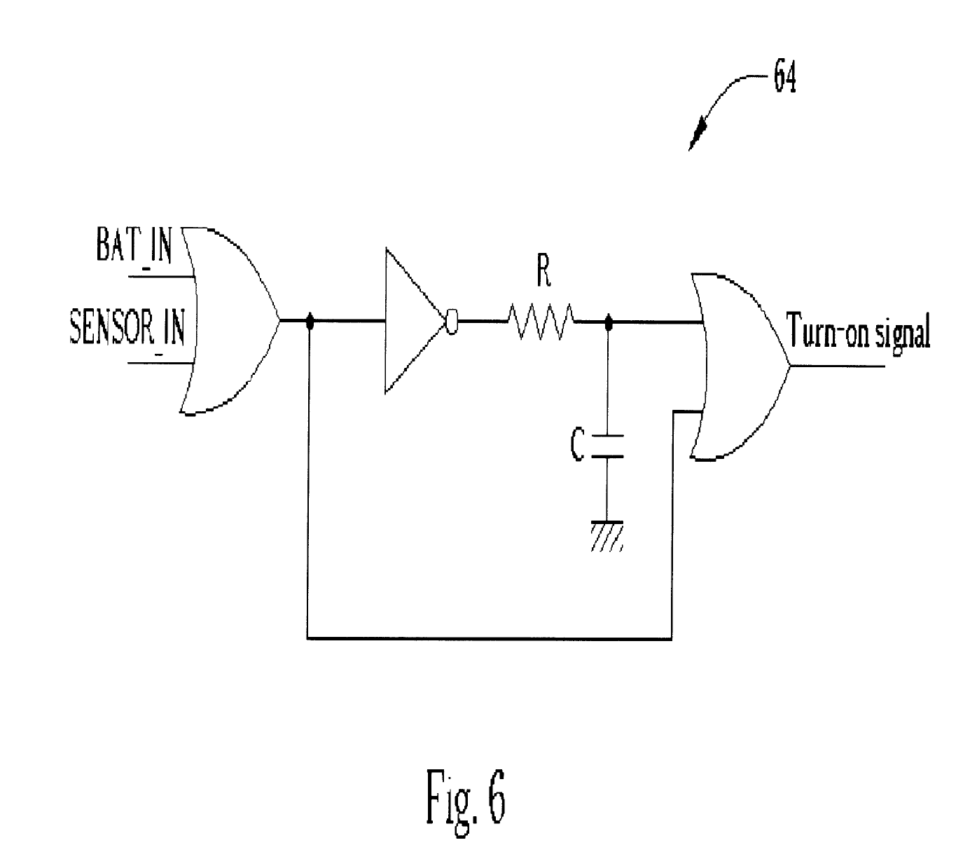

Please refer to FIG. 5, which is a flow chart showing the replacement procedure of the battery 52 shown in FIG. 4. After the (original) battery 52 is taken out, the backup battery 62 can contemporarily provide the system power. After the (new) battery 52 is installed in the housing 53, the starting module 64 will generate and send the turn-on signal to the operating processor 60. Afterwards, the operating processor 60 will automatically turn on the portable device 50. When being implemented, the practical embodiment of the starting module 64 can refer to FIG. 6. The starting module 64 includes the resistor R, the capacitor C, and other electronic elements. After the sensor 58 detects that the battery 52 is correctly installed in the battery vessel 54, the type of the battery 52 is correct, and the power volume of the battery 52 is sufficient, the sensor 58 will output a first correct signal BAT_IN. After the battery cover plate 56 is correctly joined with the battery vessel 54, the sensor 58 will output a second correct signal SENSOR_IN. When both the first correct signal BAT_IN and the second correct signal SENSOR_IN are generated, the starting module 64 can then transform the first and the second correct signalsBAT_IN, SENSOR_IN into the turn-on signal mainly according to the RC delay generated by the resistor R and the capacitor C. Finally, the turn-on signal will be transmitted to the operating processor 60 for automatically turning on the portable device 50.

In the present invention, a sensor is used to detect the battery conditions and a starting module is used to generate a turn-on signal to turn on a portable device. Therefore, after a (new) detachable battery is correctly installed, the portable device will automatically be turned on, which leads to a great convenience for users.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A portable device comprising:
a housing for accommodating a detachable battery, the detachable battery providing main power for operations of the portable device;
a sensor installed in the housing for detecting conditions of the detachable battery;
an operating processor for controlling operations of the portable device; and
a starting module electrically connected to the sensor for outputting a turn-on signal to the operating processor so as to automatically turn on the portable device after the sensor detects the detachable battery being correctly installed in the housing.

2. The portable device of claim 1, wherein the housing comprises a battery vessel and a battery cover plate, and the battery cover plate is detachably joined with the battery vessel.

3. The portable device of claim 2, wherein the sensor comprises a conducting port and a cover triggering port, wherein while the cover triggering port detects if the battery cover plate is correctly joined with the battery vessel, the conducting port detects whether the type of the detachable battery is correct and the power volume of the detachable battery is sufficient, and the conducting port also detects if the detachable battery is correctly installed in the battery vessel.

4. The portable device of claim 3, wherein when the conducting port detects that the type of the detachable battery is not correct, the power volume of the detachable battery is insufficient, or the detachable battery is not correctly installed in the battery vessel, the starting module does not output the turn-on signal to the operating processor.

5. The portable device of claim 3, wherein when the cover triggering port detects that the battery cover plate is not correctly joined with the battery vessel, the starting module does not output the turn-on signal to the operating processor.

6. The portable device of claim 3, wherein after the type of the detachable battery is correct, the power volume of the detachable battery is sufficient, the detachable battery is correctly installed in the battery vessel, and the battery cover plate is correctly joined with the battery vessel, the sensor outputs a correct signal to the starting module.

7. The portable device of claim 6, wherein when the starting module receives the correct signal from the sensor, the starting module transforms the correct signal into the turn-on signal and transmits the turn-on signal to the operating processor so as to turn on the portable device.

8. The portable device of claim 1 further comprising a backup battery for providing power for partial operations of the operating processor before the detachable battery is correctly installed in the housing.

9. The portable device of claim 1, wherein the turn-on signal is a pulse signal.

10. The portable device of claim 1 being a notebook, a mobile phone, or a personal digital assistant (PDA).

11. The portable device of claim 1, wherein the operating processor is a central processing unit (CPU).

12. A portable device that can be automatically turned on by detecting conditions of a battery, which is detachably installed in the portable device for providing main power for operations of the portable device, the portable device comprising:
a housing for accommodating the battery, the housing comprising a battery vessel and a battery cover plate, wherein the battery cover plate is detachably joined with the battery vessel for conveniently replacing the battery installed in the battery vessel;
a sensor installed in the housing for detecting conditions of the battery cover plate and the battery to determine if the battery is correctly installed the battery vessel and the battery cover plate is correctly joined with the battery vessel;
an operating processor for controlling operations of the portable device; and
a starting module electrically connected to the sensor for outputting a turn-on signal to the operating processor to automatically turn on the portable device after the battery is correctly installed in the battery vessel and the battery cover plate is correctly joined with the battery vessel.

13. The portable device of claim 12, wherein when the sensor detects that the battery is correctly installed in the battery vessel and the battery cover plate is correctly joined with the battery vessel, the sensor outputs a correct signal to the starting module.

14. The portable device of claim 12, wherein when the sensor detects that the battery cover plate is not correctly joined with the battery vessel, the starting module does not output the turn-on signal to the operating processor.

15. The portable device of claim 12, wherein when the sensor detects that the type of the battery is incorrect and the power volume of the detachable battery is insufficient, the starting module does not output the turn-on signal to the operating processor.

16. The portable device of claim 12, wherein the sensor comprises a conducting port and a cover triggering port, wherein while the cover triggering port detects if the battery cover plate is correctly joined with the battery vessel, the conducting port detects whether the type of the detachable battery is correct and the power volume of the detachable battery is sufficient, and the conducting port also detects if the detachable battery is correctly in stalled in the battery vessel.

17. The portable device of claim 12 further comprising a backup battery for providing power for partial operations of the operating processor before the detachable battery is correctly installed in the housing.

18. The portable device of claim 12, wherein the turn-on signal is a pulse signal.

19. The portable device of claim 12 being a notebook, a mobile phone, or a personal digital assistant (PDA).

20. The portable device of claim 12, wherein the operating processor is a central processing unit (CPU).
